(19) United States
(12) Patent Application Publication
(10) Pub. No.: US 2011/0261392 A1
(43) Pub. Date: Oct. 27, 2011

(54) METHOD FOR PROCESSING PDF ELEMENTS

(76) Inventor: Irena Mail, Tzur lgal (IL)

(21) Appl. No.: 12/767,878

(22) Filed: Apr. 27, 2010

(51) Int. Cl. G06F 3/12

(52) U.S. Cl. 358/1.15

(57) ABSTRACT

A method for selecting a processing scheme for printing portable document format (PDF) elements (102) includes providing a PDF element (104) stored on a computer to a PDF analyzer (108); selecting a printer (140); determining characteristics of the printer; analyzing the PDF element for graphical features; determining whether at least a first processor or a second processor is best for processing the graphical features based on the printer characteristics; providing the PDF element to the first processor or to the second processor based on the determination; processing the PDF element on said first processor or said second processor based on the determination to produce a raster ready-to-print (RTP) object (132); sending the RTP object to said printer using a dedicated printer interface (136); and printing (RTP) file on said printer.

### CROSS REFERENCE TO RELATED APPLICATIONS

Reference is made to commonly-assigned copending U.S. patent application Ser. No. ______ (Attorney Docket No. 96252/NAB), filed herewith, entitled SYSTEM FOR PROCESSING PDF ELEMENTS, by Irena Mail; and U.S. patent application Ser. No. 11/858,477, filed Sep. 20, 2007, now U.S. Publication No. 2009/0080025, entitled PARALLEL PROCESSING OF PAGE DESCRIPTION LANGUAGE, by Aronshtam et al., the disclosure of which is incorporated herein.

### FIELD OF THE INVENTION

The present invention relates to method and apparatus for extraction of document properties from a portable document format (PDF) document and processing of the PDF document according to the extracted document properties.

### BACKGROUND OF THE INVENTION

PostScript language is well known to a person of ordinary skill in the art. PostScript is a page description language (PDL) that contains a rich set of commands that is used to describe pages in the print job. A principal difference between PostScript and other PDLs, e.g. IPDS, PDF, PCL, PPML, is that it is a programming language. This provides power and flexibility in expressing page content, but the flexibility comes at a high price; in a general PostScript job, pages are not easy to interpret. In order to correctly interpret pages or to perform meaningful transformations on PostScript jobs, a PostScript interpreter is needed. Adobe Configurable PostScript Interpreter (CPSI) is one example of a PostScript interpreter, which processes a PostScript job and produces bitmaps. Adobe Distiller is another example of a PostScript interpreter, which processes a PostScript job and produces a portable document format (PDF) file, as opposed to bitmaps.

PDF is a file format, not a programming language, so that flow control commands such as “if” and “loop” are removed, while graphics commands such as “line to” remain. Often, the PostScript-like PDF code is generated from a source PostScript file. The graphics commands that are output by the PostScript code are collected and tokenized; any files, graphics, or fonts to which the document refers also are collected; then, everything is compressed to a single file. Therefore, the entire PostScript world (fonts, layout, and measurements) remains intact.

As a document format, PDF has several advantages over PostScript:
a) PDF contains tokenized and interpreted results of the PostScript source code, for direct correspondence between changes to items in the PDF page description and changes to the resulting page appearance.
b) PDF (from version 1.4) supports true graphic transparency; PostScript does not.
c) PostScript is an imperative programming language with an implicit global state, so instructions accompanying the description of one page can affect the appearance of any following page. Therefore, all preceding pages in a PostScript document must be processed in order to determine the correct appearance of a given page, whereas each page in a PDF document is unaffected by the others. As a result, PDF viewers allow the user to quickly jump to the final pages of a long document, whereas a Postscript viewer needs to process all pages sequentially before being able to display the destination page (unless the optional PostScript document structuring conventions have been carefully complied with).

APPE Adobe® PDF Print Engine (also known by code name Monza) is a software development kit (SDK) employed by Adobe print partners to build industry-leading printing systems. It is designed for the needs of both offset and digital print production. With new features designed for personalized publishing, Adobe PDF Print Engine delivers unprecedented freedom of collaboration for designers, printers, and marketers. Creative professionals can design personalization directly into their content, producing PDF master files that flow through the entire print process without unnecessary intervention. Print solutions powered by Adobe PDF Print Engine allow PDF files to be rendered natively, using the same technology as Adobe Acrobat® and Creative Suite® software, helping to ensure that complex designs and effects, even variable print elements with transparency, are efficiently and reliably reproduced.

Adobe PDF Print Engine provides job definition format (JDF) control for late binding flexibility. Device-dependent processes such as color management, trapping, and imposition can be driven by JDF instructions inside the Adobe PDF Print Engine and thus deferred until jobs are ready to be rendered. This architecture, which decouples content (PDF) from process (JDF), allows print production professionals to quickly accommodate last-minute changes and easily configure PDF jobs for various types of devices and presses. Designers are freed to focus their energies on the creative presentation of content, producing a single digital master that can be repurposed for other publishing platforms such as web, e-mail, and mobile. Adobe PDF Print Engine enables Adobe solution partners to provide full-fidelity desktop previewing for designers and printers alike. The advanced PDF rendering engine used for final output is the same as the one used to view jobs at every point in the workflow. One of the main known advantages of APPE is efficient processing of Native PDF and live transparency rendering with no flattening.

Many features in a PDF document may be processed in an efficient manner by APPE, but still some are still better processed by the CPSI engine, which poses a dilemma by prepress user which route to choose when processing PDF documents.

### SUMMARY OF THE INVENTION

Briefly, according to one aspect of the present invention a method and a system for selecting a processing scheme for PDF elements within PDL document are presented.

The present invention includes few of the following steps: a PDF element is provided to a PDF analyzer; a printer is selected for printing the PDL document; the characteristics of the selected printer are determined; and the PDF element is analyzed to search for graphical features suitable a processor of a type one or for a processor of type two.

The graphical features found by the PDF analyzer are then forwarded to a decision module. The decision module is configured to decide according to the graphical features found and printer characteristics whether the PDF element is better suited to be processed by processor of type one or by processor of type two.

The PDF element is then moved for processing by processor of type one or by processor of type two according to the results of the decision module to produce a raster ready-to-print (RTP) object.

The RTP object is transferred the printer using a dedicated printer interface, and the printed on the selected printer.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic illustrating a flowchart of consuming PDF documents, inspecting its properties and processing the PDF documents according the properties found in the document.

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

While the present invention is described in connection with one of the embodiments, it will be understood that it is not intended to limit the invention to this embodiment. On the contrary, it is intended to cover all alternatives, modifications and equivalents as covered by the appended claims.

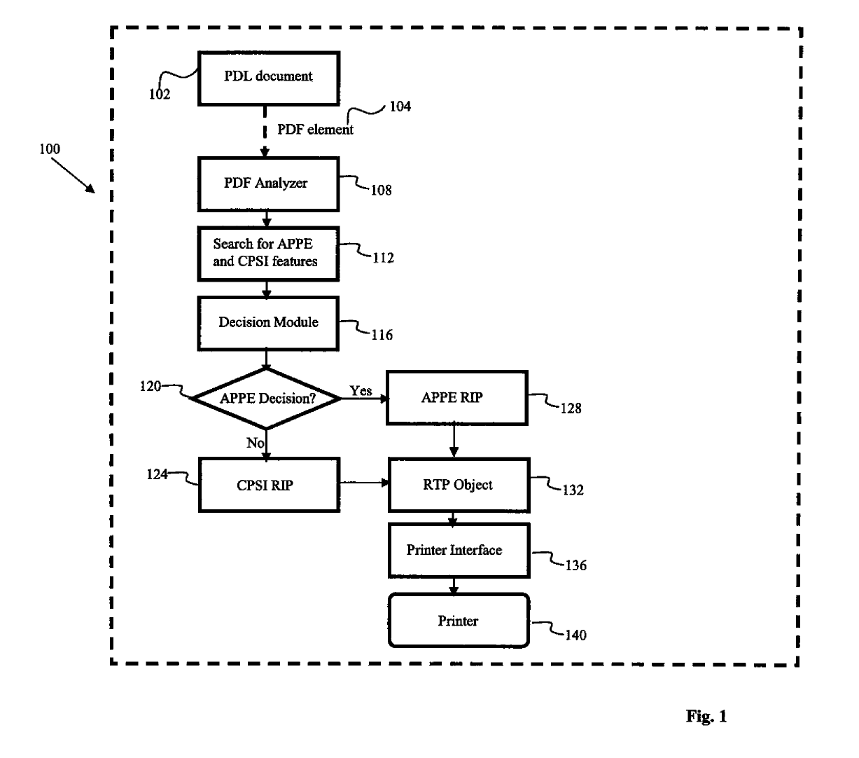

FIG. 1 shows the main embodiment of the present invention. A PDF element 104 is brought into a prepress system 100 (few system elements are shown) for processing. A PDF element 104 can be represented by a complete PDF document or alternatively by at least one PDF object embedded in any page description language (PDL) document 102, which can be other than a PDF. The PDL document 102 will be printed on printer 140.

Each of the PDF elements 104 in a PDL document are first analyzed by a PDF analyzer 108. The PDF analyzer 108 searches inside the content of PDF element 104 for graphical features 112, suitable to be effectively processed by an APPE raster image processor (RIP) 128 or alternatively for graphical features 112 which are better suited to be processed by a CPSI RIP 124. The selection of the suitable raster image processor (124 or 128) for the graphical features 112 found in the PDF element 104 will be also based on printer 140 characteristics.

Examples of features better processed by an APPE RIP 128 are graphical transparencies and overprint, whereas documents including just text with no transparencies are more effectively processed by a CPSI RIP 124.

The features 112 found in PDF element 104 are then inserted into a decision module 116. The decision module 116 weights the various found features 112, as to their fit to be processed either by an APPE or a CPSI RIP. The PDF element 104 is transferred in accordance with the decision 120 to APPE RIP 128 or to CPSI RIP 124 for processing to create a ready-to-print (RTP) object 132. The RTP object 132 is then sent by the printer interface electronic board 136 to printer 140 for printing.

The embodiment described above can also be implemented by utilizing more then two types of processors. The invention has been described in detail with particular reference to certain preferred embodiments thereof, but it will be understood that variations and modifications can be effected within the scope of the invention.

### PARTS LIST

100 prepress system—selected elements
102 PDL document
104 PDF element
108 PDF analyzer
112 search for APPE and/or CPSI features in PDF
116 decision module
120 decision point whether process PDF via APPE
124 CPSI processor
128 APPE processor
132 ready-to-print objects
136 printer interface board
140 printer

1. A method for selecting a processing scheme for printing portable document format (PDF) elements comprising the steps of:
providing a PDF element stored on a computer to a PDF analyzer;
selecting a printer;
determining characteristics of said printer;
analyzing said PDF element for graphical features;
determining whether at least a first processor or a second processor is best for processing said graphical features based on said printer characteristics;
providing said PDF element to said first processor or to said second processor based on said determination;
processing said PDF element on said first processor or said second processor based on said determination to produce a raster ready-to-print (RTP) object;
sending said RTP object to said printer using a dedicated printer interface; and
printing said RTP file on said printer.

2. The method according to claim 1 comprising:
determining whether a third is best for processing said graphical features based on said printer characteristics.

3. The method according to claim 1 wherein said PDF element is a PDF document.

4. The method according to claim 1 wherein said PDF element is a PDF object embedded in a print description language (PDL) document wherein said PDL document is not a PDF document.
